(19) United States
(12) Patent Application Publication
(10) Pub. No.: US 2014/0262062 A1
(43) Pub. Date: Sep. 18, 2014

(54) METHOD AND APPARATUS FOR REDUCING THE SPACE REQUIREMENT OF A FLAT COUNTERBALANCING SPRING WITH A NEGATIVE GRADIENT BY RESTRAINING OR CONTAINING THE FREE COIL OF THE SPRING

(71) Applicant: HOMERUN HOLDINGS CORPORATION, Pensacola, FL (US)

(72) Inventor: FRED C. HIGGINS, CANTONMENT, FL (US)

(73) Assignee: HOMERUN HOLDINGS CORPORATION, PENSACOLA, FL (US)

(21) Appl. No.: 13/842,071

(22) Filed: Mar. 15, 2013

(51) Int. Cl. E06B 9/60

(52) U.S. Cl. CPC E06B 9/60
USPC 160/84.01; 185/37; 74/63

(57) ABSTRACT

Embodiments of the invention relate to a method and apparatus for reducing the space requirements of, and improving the performance of, a flat type spring formed to produce a negative gradient torque. In an embodiment, a retainer can be added over at least two coils on the free end of each spring to reduce the space requirement for the spring. Embodiments of the invention can incorporate a flat type spring with a negative gradient having reduced space requirements into a shade or blind. Such a shade or blind will then be able to fit into a smaller area or volume. Specific embodiments can use multiple springs restrained in accordance with the subject invention to achieve a desired counterbalancing of the shade or blind. Further embodiments can incorporate gearing to alter the torque output of the springs. Further specific embodiments can incorporate one or more springs restrained in accordance with the invention and gearing to alter the torque output of the one of more springs.

### BACKGROUND OF INVENTION

The use of negative gradient springs are found in several places in the prior art. The ways to produce this type of spring out of flat spring steel is varied. There are designs that change the curvature of the spring and others that add holes or slots, and/or taper the spring. Other than placing one coil of the spring on a spool with flanges and placing the assembly in housing, no other provisions are made to limit or contain the size of the spring allowing the spring to fit into small areas.

U.S. Pat. No. 6,283,192 (Toti) teaches a spring drive system for window covers, which includes a so-called flat spring drive and the combination whose elements are selected from a group which includes (1) a band transmission which provides varying ratio power transfer as the cover is opened and closed; (2) a gear system selected from various gear sets which provide frictional holding force and fixed power transfer ratios; and (3) a gear transmission which provides fixed ratio power transfer as the cover is opened or closed. The combination permits the spring drive force at the cover to be tailored to the weight and/or compression characteristics of the window cover such as a horizontal slat or pleated or box blind as the cover is opened and closed.

U.S. Pat. No. 6,536,503 (Anderson et al.) teaches a modular blind transport system for a window blind application. The complete system may be assembled form a relatively small number of individual modules to obtain working systems for a very wide range of applications, including especially a category of counterbalanced blinds wherein a relatively small external input force may be used to raise or lower the blind, and/or to open or close the blind.

U.S. Pat. No. 6,648,050 Toti teaches a spring drive system useful for window covers, which comprises one or more coil spring drives or flat spring drives and the combination whose elements are selected from one or more of a group which includes (1) a band or cord transmission which provides varying ratio power transfer as the cover is opened and closed; (2) gear means comprising various gear sets which provide frictional holding force and fixed power transfer ratios; (3) a gear transmission which provides fixed ratio power transfer as the cover is opened or closed; (4) crank mechanisms; (5) brake mechanisms; and (6) recoiler mechanisms. The combination permits the spring drive force to be tailored to the weight and/or compression characteristics of an associated window cover such as a horizontal slat or pleated or box blind as the cover is opened and closed.

U.S. Pat. No. 6,957,683 (Toti) teaches a spring drive system useful for window covers, which comprises one or more coil spring drives or flat spring drives and the combination whose elements are selected from one or more of a group which includes (1) a band or cord transmission which provides varying ratio power transfer as the cover is opened and closed; (2) gear means comprising various gear sets which provide frictional holding force and fixed power transfer ratios; (3) a gear transmission which provides fixed ratio power transfer as the cover is opened or closed; (4) crank mechanisms; (5) brake mechanisms; and (6) recoiler mechanisms. The combination permits the spring drive force to be tailored to the weight and/or compression characteristics of an associated window cover such as a horizontal slat or pleated or box blind as the cover is opened and closed.

U.S. Pat. No. 6,983,783 (Carmen et al.) teaches a motorized shade control system including electronic drive units (ED Us) having programmable control units directing a motor to move an associated shade in response to command signals directed to the control units from wall-mounted keypad controllers or from alternate devices or control systems connected to a contact closure interface (CCI). Each of the ED Us, keypad controllers and CCIs of the system is connected to a common communication bus. The system provides for initiation of soft addressing of the system components from any keypad controller, CCI or EDU. The system also provides for setting of EDU limit positions and assignment of EDUs to keypad controllers from the keypad controllers or CCIs. The system may also include infrared receivers for receiving infrared command signals from an infrared transmitter.

U.S. Pat. No. 7,185,691 (Toti) teaches a reversible pull cord mechanism adapted for rotating a shaft in one direction when the pull cord is pulled in a first direction and rotating the shaft in the opposite direction when the pull cord is pulled in a second direction.

Accordingly, there is a need for a method and apparatus to reduce the space requirements of a flat negative gradient counterbalance spring. The gear reduction can be changed to perfect the counterbalance and the performance of the spring or springs.

### BRIEF SUMMARY

Embodiments of the invention relate to a method and apparatus for reducing the space requirements of, and improving the performance of, a flat type spring formed to produce a negative gradient torque. In an embodiment, a retainer can be added over at least two coils on the free end of each spring to reduce the space requirement for the spring. Embodiments of the invention can incorporate a flat type spring with a negative gradient having reduced space requirements into a shade or blind. Such a shade or blind will then be able to fit into a smaller area or volume. Specific embodiments can use multiple springs restrained in accordance with the subject invention to achieve a desired counterbalancing of the shade or blind. Further embodiments can incorporate gearing to alter the torque output of the springs. Further specific embodiments can incorporate one or more springs restrained in accordance with the invention and gearing to alter the torque output of the one of more springs.

### BRIEF DESCRIPTION OF DRAWINGS

FIG. 1 shows a perspective view of a shade or blind assembly incorporating an embodiment of the subject invention.

FIG. 2 shows a front or plan view of the shade or blind assembly of FIG. 1.

FIG. 3 shows a side or end view of the shade or blind assembly of FIG. 1.

FIG. 4 shows a cut away perspective view of a shade or blind assembly incorporating an embodiment of the subject invention with the front cover removed and the endplate removed to better see the location of the negative gradient springs and the retainer. The flange of the spring spool for the lower spring coil is also removed to better show the spring.

FIG. 5 shows a side or end view of the shade or blind assembly of FIG. 4.

FIG. 6 shows an enlarged view of the shade or blind assembly of FIG. 4 to better show the placement of the retainer.

FIG. 7 shows a perspective sectioned view of the spring components of the shade or blind assembly of FIG. 4.

FIG. 8 shows an exploded components view of the shade or blind assembly of FIG. 4.

### DETAILED DISCLOSURE

Embodiments of this invention relate to a method and apparatus for reducing the space requirement of a flat counterbalancing negative gradient spring. In an embodiment the space requirement is reduced by retaining one or more coils of the free end of the spring. A flat counterbalancing negative gradient spring has a main coil, herein referred to as the spring lower coil 7, and a free end, which is also coiled and forms the spring free end coil 8. A reduction in size of the spring can be accomplished with a retainer 9. The retainer 9 maintains the relative position of an end portion of the free end of the spring to a portion of the free end of the spring adjacent to the end portion when the spring free end coil 8 is formed, where when the free end of the spring is formed a first, or most inner, coil of the spring free end coil 8 and the portion of the free end of the spring adjacent to the end portion forms the next, or second most inner, coil of the spring free end coil 8. It should be noted that coil is used in the sense of each winding of the spring, when we refer to, for example, inner most coil and inner coil, and coil is used in the sense of the combination of all of the individual windings of the spring that creates the spring free end coil. Maintaining the relative position of the end portion making up the inner most coil and the adjacent portion making up the second most inner coil, the free end of the spring is restricted from fully uncoiling. In the embodiment shown in FIGS. 1-8, the negative gradient spring is shown in a shade or blind system. In further embodiments, such a restricted negative gradient spring can be utilized in other applications that would be appreciated by a person skilled in the art are also contemplated herein.

FIGS. 1-3 show an embodiment with a frame assembly having a head rail 2, two vertical side pieces 3, and a sill 4. The head rail 2 portion of the frame assembly holds a shade assembly 1 incorporating a counterbalance system with a drive system, and a shade 10 with a bottom bar 11. The shade assembly can be stored and deployed manually or with a motor located in the shade assembly 1. The motor may be manually activated, or software-controlled to enable automatic scheduling or additional features. The shade 10 and the bottom bar in this embodiment are together known as a cellular type or accordion type shade. Cellular type or accordion type shades are traditionally counterbalanced with flat constant torque springs. In contrast, the embodiment of the subject invention shown in FIGS. 4-8 instead uses a spring 12 referred to as a “negative gradient” spring, such that the torque output from the spring 12 decreases as the spring is wound. Referring to FIG. 5, the shade is up and a large portion of the spring is in the main coil 7. This is the position that the spring provides a large torque. As the shade is lowered, the spring is wound onto the spring free end coil 8 and from the main coil 7, such that the torque provided by the spring is reduced. Specific embodiments of the spring 12 can be formed from a variable curvature of the spring that develops the negative gradient output. This variable curvature is formed in the spring and normally creates a coil of a certain diameter on the free end of the spring in addition to the main coil of the spring, which here serves as the lower coil 7. Adjusting the properties of the curvature results in embodiments having different spring geometries and torque outputs. A specific spring used in the embodiment shown in FIGS. 4-8 normally creates a 0.625 inch diameter coil on the free end of the spring.

A specific embodiment of the invention employs a retainer 9 on the spring free end coil 8. The retainer is inserted over one or more of the inner coils of free end coil 8, thus reducing the size of the coil on the free end of the spring. In the embodiment shown in FIGS. 4-8, the retainer 9 reduces the spring free end coil 8 from 0.625 inches to 0.400 inches in diameter. Alternative configurations can use a different retainer in order to achieve different reductions in the spring free end coil 8 diameter. In one embodiment, the retainer 9 is inserted over one inner coil. In other embodiments, the retainer 9 is inserted over two inner coils. In further embodiments, the retainer can be inserted over three or more inner coils. The spring system in the embodiment shown in FIGS. 4-8 has at least one spring 12 and can have 2, 3, 4, or more springs 12, where two springs are shown in FIG. 7. Further embodiments can have springs 12 of different sizes and configurations to match the counterbalance needs of each shade assembly 1, by, for example, stacking spring housings 6 as shown, or alternatively, by placing one or more springs 12 on both sides of the head rail 2. In the embodiment that is shown in FIGS. 4-8, two identical springs 12 are used, but other embodiments can have non-identical springs and/or have more than two springs 12.

FIG. 6 shows the placement of retainer 9 over a number of inner coils of the spring free end coil 8. The retainer 9 then restricts these inner coils, or windings, from expanding larger than the size of the retainer as the retainer provides a higher force to constrain the inner windings from expanding than the force the inner windings within the retainer push to expand the retainer with. Other shapes and designs for a retainer to restrict the diameter of one or more inner coils, or windings, can be utilized in accordance with the invention. In this way, the retainer limits the free end spring coil 8 through the moving distance of the shade 10 and bottom bar 11 from an open to close position and back. The retainer 9 shown in FIG. 6 is thin enough so that the retainer holds the inner coils, or windings, without binding as the spring 12 is transferred from main coil to spring free end coil and back. In the embodiment shown in FIGS. 4-8, the retainer is made from 0.0060 inch (0.1524 mm) thick steel. However, retainers 9 having different thicknesses and composition materials can be utilized. It is noted that the retainer shown in FIG. 6 has an annular shape and has an opening that allows the spring to transition from within the volume that would be encircled by the retainer if the retainer had no opening to outside the volume that would be encircled if the retainer had no opening. Openings of different sizes can be utilized so long as the spring can pass through, preferably without deformation, and the retainer can hold the inner windings. In this way, the opening can be longer than shown in FIG. 6 and can also be larger. The retainer 9 prevents the free end spring coil 8 from uncontrolled expansion, which would require additional area, or volume, for the spring system to operate.

Specific embodiments have multiple springs 12 within spring housings 6 that are added by stacking the assemblies. These embodiments are only limited by the width of the opening that the shade 10 is covering, but as the width of the shade 10 increases to cover the opening, so does the suspended weight, which may require additional springs 12 and spring housings 6 to achieve a proper counterbalance.

For further torque control, in specific embodiments, the drive system has a gear system 14. A specific gear system, using a pair of gears, is shown in FIGS. 7 and 8. In the embodiment shown the ratio of the gears is 1:1. The gears can be changed to other ratios, such as 2:1, 1:2, or a non-integer ratio between 2:1 and 1:2. Other gear ratios can also be used. The gear system can alter the torque output of the springs 12 in order to tune the counterbalancing of the shade 11 and bottom bar 10. In the embodiment shown in FIGS. 7-8, the gear system uses a pair of gears. Other embodiments can utilize gear systems having more than two gears.

Aspects of the invention, such as controlling the motor to raise and/or lower the shade, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile disks (DVD), holographic media or other optical disk storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCE NUMBERS

### Parts

1. Shade assembly
2. Head rail
3. Side rails
4. Sill
5. Handle
6. Spring housing
7. Spring lower coil
8. Spring free end coil
9. Spring retainer
10. Shade
11. Bottom bar
12. Spring
13. Spring spool
14. Gears
15. Bearing
16. Bearing housing
17. Tube driver
18. Tube

I claim:

1. A spring system, comprising:
a spring, wherein the spring is a flat type negative gradient spring having a torque output as a function of distance along the spring from a distal end to a proximal end that has a negative gradient;
a spool, wherein the spring is wound onto the spool such that the proximal end is innermost on the spool to create a main coil and the distal end is free and forms a spring free end coil, wherein the main coil and the spring free end coil are wound in opposite directions; and
a retainer, wherein the retainer is positioned such that one or more inner windings of the spring free end coil are restricted from expanding to a diameter larger than an inner diameter of the retainer.

2. The system according to claim 1, wherein a diameter of the spring free end coil with the retainer is smaller than the diameter of the spring free end coil without the retainer.

3. The system according to claim 1, further comprising:
a first gear; and
a second gear,
wherein the first gear is coupled to the spool such that a spool torque is applied about a spool axis by the spool to the first gear, a force is applied by the first gear to the second gear to create an output torque about an output axis applied to an object coupled to the second gear, wherein the output axis is substantially parallel to the spool axis,
wherein the output axis is shifted with respect to the spool axis by a shift distance in a direction perpendicular to the spool axis.

4. The system according to claim 3, wherein a gear ratio between the first gear and the second gear is in the range 1:2 to 2:1.

5. The system according to claim 1, wherein the one or more inner windings of the spring free end coil is four inner windings.

6. The system according to claim 1, wherein the spool outputs a spool torque about a spool axis to an object.

7. The system according to claim 1, further comprising:
at least one additional flat type negative gradient spring having a corresponding at least one additional torque output as a function of distance along the corresponding at least one additional spring from a corresponding at least one additional distal end to a corresponding at least one additional proximal end that has a corresponding at least one additional negative gradient;
a corresponding at least one additional spool, wherein the corresponding at least one additional spring is wound onto the corresponding at least one additional spool such that the corresponding at least one additional proximal end is innermost on the corresponding at least one additional spool to create a corresponding at least one additional main coil and the corresponding at least one additional distal end is free and forms a corresponding at least one additional spring free end coil, wherein the corresponding at least one additional main coil and the corresponding at least one additional spring free end coil are wound in opposite directions; and
a corresponding at least one additional retainer, wherein the corresponding at least one additional retainer is positioned such that corresponding at least one additional one or more inner windings of the corresponding at least one additional spring free end coil are restricted from expanding to a corresponding at least one additional diameter larger than a corresponding at least one additional inner diameter of the corresponding at least one additional retainer.

8. The system according to claim 6, wherein each of the corresponding at least one additional spring is the same as the spring, wherein each of the corresponding at least one additional spool is the same as the spool, wherein the corresponding at least one additional retainer is the same as the retainer.

9. The system according to claim 8, wherein the corresponding at least one additional spool outputs a corresponding at least one additional spool torque about the spool axis to corresponding at least one additional object.

10. The system according to claim 7, wherein the at least one additional spring is three additional springs.

11. A shade or blind system, comprising:
a shade or blind;
a spring system, wherein the spring system comprises:
a spring, wherein the spring is a flat type negative gradient spring having a torque output as a function of distance along the spring from a distal end to a proximal end that has a negative gradient;
a spool, wherein the spring is wound onto the spool such that the proximal end is innermost on the spool to create a main coil and the distal end is free and forms a spring free end coil, wherein the main coil and the spring free end coil are wound in opposite directions; and
a retainer, wherein the retainer is positioned such that one or more inner windings of the spring free end coil are restricted from expanding to a diameter larger than an inner diameter of the retainer,
wherein the spool outputs a spool torque about a spool axis to the shade or blind.

12. The system according to claim 11, wherein a diameter of the spring free end coil with the retainer is smaller than the diameter of the spring free end coil without the retainer.

13. The system according to claim 11, wherein the spool outputs the spool torque about the spool axis to the shade or blind via a gear system, wherein the gear system comprises:
a first gear; and
a second gear,
wherein the first gear is coupled to the spool such that a spool torque is applied about a spool axis by the spool to the first gear, a force is applied by the first gear to the second gear to create an output torque about an output axis applied to the shade or blind coupled to the second gear, wherein the output axis is substantially parallel to the spool axis,
wherein the output axis is shifted with respect to the spool axis by a shift distance in a direction perpendicular to the spool axis.

14. The system according to claim 13, wherein a gear ratio between the first gear and the second gear is in the range 1:2 to 2:1.

15. The system according to claim 11, wherein the one or more inner windings of the spring free end coil is four inner windings.

16. The system according to claim 11, wherein the spool outputs a spool torque about a spool axis to an object.

17. The system according to claim 11, wherein the spring system further comprises:
at least one additional spring, wherein the at least one additional flat type negative gradient spring having a corresponding at least one additional torque output as a function of distance along the corresponding at least one additional spring from a corresponding at least one additional distal end to a corresponding at least one additional proximal end that has a corresponding at least one additional negative gradient;
a corresponding at least one additional spool, wherein the corresponding at least one additional spring is wound onto the corresponding at least one additional spool such that the corresponding at least one additional proximal end is innermost on the corresponding at least one additional spool to create a corresponding at least one additional main coil and the corresponding at least one additional distal end is free and forms a corresponding at least one additional spring free end coil, wherein the corresponding at least one additional main coil and the corresponding at least one additional spring free end coil are wound in opposite directions; and
a corresponding at least one additional retainer, wherein the corresponding at least one additional retainer is positioned such that corresponding at least one additional one or more inner windings of the corresponding at least one additional spring free end coil are restricted from expanding to a corresponding at least one additional diameter larger than a corresponding at least one additional inner diameter of the corresponding at least one additional retainer.

18. The system according to claim 16, wherein each of the corresponding at least one additional spring is the same as the spring, wherein each of the corresponding at least one additional spool is the same as the spool, wherein the corresponding at least one additional retainer is the same as the retainer.
